(19) United States
(12) Patent Application Publication
(10) Pub. No.: US 2015/0253238 A1
(43) Pub. Date: Sep. 10, 2015

(54) WIDE BANDWIDTH GW PROBE FOR TUBE AND PIPE INSPECTION SYSTEM

(71) Applicant: ACOUSTICEYE LTD, Tel Aviv (IL)

(72) Inventor: Dov Furman, Rehovot (IL)

(73) Assignee: ACOUSTICEYE LTD, Tel Aviv (IL)

(21) Appl. No.: 14/641,418

(22) Filed: Mar. 8, 2015

Related U.S. Application Data
(60) Provisional application No. 61/950,158, filed on Mar. 9, 2014.

(51) Int. Cl. G01N 19/08; G01D 5/14; B06B 1/06

(52) U.S. Cl. CPC G01N 19/08; B06B 1/06; G01D 5/14

(57) ABSTRACT

A tube inspection system that includes a guided-wave-transducer mechanism (GWTM) that is associated with a tube that is being inspected. The GWTM can have one ring with ‘N’ guided-wave transducers (GWTs) distributed thereon, and another ring with ‘M’ guided-wave transducers (GWTs) distributed thereon. A controller excites mechanical waves by the GWTs of the first ring that propagate in the wall of the tube being inspected and along its axis. The ‘M’ GWTs of the second ring obtain received mechanical waves and convert them to electronic signals. The ‘M’ electronic signals are processed to provide a measured signal in which a wanted mode is enhanced.

### CROSS-REFERENCE TO RELATED APPLICATIONS

This present application claims priority to the U.S. provisional patent application Ser. No. 61/950,158 filed on Mar. 9, 2014 and is related to a Patent Cooperation Treaty application (PCT) application number PCT/IL2013/000054 that was filed in the Israeli Receiving Office on Jun. 10, 2013, the contents of each of these are incorporated herein by reference.

### FIELD OF INVENTION

The present disclosure relates to the field of non-destructive testing and more particularly, the present disclosure is in the technical field of pipe inspection.

### DESCRIPTION OF BACKGROUND ART

There are several techniques, presently in use, for conducting tube inspections. These techniques can be divided into two main groups: traversing and non-traversing. The traversing methods employ a probe, which can inspect only the portion of the tube in its immediate vicinity. In order to inspect an entire tube, the probe is tethered to a cable by which the probe is pushed all the way down from one end of the tube to the other, and then pulled back. Traversing methods are slow, prone to wear and tear of the probe, and eventual failure. One example of a traversing inspection method is Eddy Current Testing, and related methods such as Remote Field Testing and Magnetic Flux Leakage testing. All these traversing methods are electromagnetic methods, having varying degrees of accuracy. Another example is the widely known IRIS (Internal Rotating Inspection System), which is based on ultrasound. IRIS is based on use of a probe that scans the tube wall in a spiral manner using an ultrasound beam propagating in water. It is much slower than the electromagnetic methods and requires cleaning the tube wall down to the metal, which is an expensive process. Throughout this disclosure, the terms tube and pipe can be used interchangeably and the term tube can be used as representative term for both terms.

Non-traversing methods are based on inserting a probe a relatively short distance into a tube under test, and then applying a physical method for inspecting the entire tube from this location. One such method is Acoustic Pulse Reflectometry (APR). In the APR method, an acoustic signal (which could be, for example, but not limited to a pulse or a pseudo noise signal, swept sine, etc.) is propagated through the air inside the tube. Any changes in the cross sectional profile of the tube creates reflections, which propagate back down to the probe where they can be recorded and later analyzed. APR gives good results in detecting anomalies on the interior surface or cross-sectional profile of a tube, such as blockages, through holes, and circumferential changes in cross section of a tube as a few non-limiting examples. APR has several advantages: APR is fast, it can accurately assess blockages, and it is very sensitive to through-holes, for example. A reader who wishes to learn more about APR systems is invited to read U.S. Pat. No. 7,677,103, or US pre-granted publication number US2011-0166808, or U.S. patent application Ser. No. 13/403,984.

An inspection method, which is known widely as the Guided-Wave (GW) method, is based on propagating mechanical waves within the tube wall itself. These waves can be, for example but not limited to, a torsional or longitudinal or flexural wave, and the excitation signal can be for example, but not limited to, a pulse or a pseudo noise signal, swept sine, etc. The torsional waves are marked with the letter ‘T’; the longitudinal waves are marked with the letter ‘L’; the flexural waves are marked with the letter ‘F’. Torsional waves are those in which particle displacement is in the circumferential direction, but the wave propagates down the axis of the tube. Longitudinal waves are those in which the particle displacement is in the axial direction, similarly to the direction of propagation of the wave. Particle displacement in torsional waves and longitudinal waves is independent of the azimuthal angle, therefore they are axisymmetric. Each type of the above waves are associated with:
An infinite number of higher order axisymmetric modes, depending on the number of nodal surfaces through the thickness of the tube wall, denoted T(0,m), m=1, 2, 3, . . . for torsional modes and L(0,m), m=1, 2, 3 . . . for longitudinal modes; These modes have different cut-on frequencies and different dispersion curves.
A doubly infinite number of non-axisymmetric modes, denoted F_{T}(n,m)—where n=1, 2, 3 . . . and m=1, 2, 3 . . . for flexural modes associated with torsional waves, and F_{L}(n,m)—where n=1, 2, 3 . . . and m=1, 2, 3 . . . for flexural modes associated with longitudinal waves. These modes have different cut-on frequencies and different dispersion curves.

Different modes of excitation are well known to a person having ordinary skill in the art and will not be further described. A reader who wishes to learn more about mechanical waves is invited to read technical documents such as but not limited to the article “Flexural torsional guided wave mechanics and focusing in pipe”, Journal of Pressure Vessel Technology Vol. 127, November 2005, pp. 471-478 written by Zongqi Sun, Li Zhang, Joseph L. Rose, for example.

Interfacing to the tube can be done from the interior of the tube by inserting a probe with one or more GW transducers in one of the openings of the tube. Alternatively the interfacing can be done from the external side of the tube by associating one or more GW transducers with the outer circumference of the tube.

The GW technique is sensitive to the degree of material loss. Any changes in the tube wall properties or dimensions will create a reflection, which can be recorded and analyzed. GW is fast and sensitive to flaws on both the outside and inside surfaces of the tube.

Typically GW inspection systems have limited bandwidth (BW). In order to improve the resolution of the inspection system high frequency and wide bandwidth is needed.

### SUMMARY OF THE DISCLOSURE

In order to detect small defects, excitation of high frequencies having short wavelengths is needed. For example, mechanical waves with frequencies above 200 KHz may be needed in order to detect defects of length 2-3 millimeters. Further, in order to achieve high resolution and accurate sizing GW systems need to be broadband from low frequencies up to high frequencies, for example from 20 kHz up to 400 kHz.

It is well known to a person with ordinary skill in the art that exciting mechanical waves in tubes is associated with excitation of a plurality of modes such as T, L and F_{L} and F_{T} etc. Some of these modes interfere with the desired measurement and are therefore termed “unwanted modes”. The unwanted modes may be generated in the inspected tube in addition to the wanted modes.

For example in order to use mode T(0,1) as the wanted mode, an embodiment of the system can transmit substantially the same signal simultaneously from all transducers on a ring of N transducers. The transducers can be distributed substantially evenly on the circumference. However, in such a case, a plurality of unwanted modes will be excited. The dominant unwanted modes interfering with the measurement may include: F_{T}(N,1); F_{T}(2N,1) . . . ; F_{L}(N,1); F_{L}(2N,1); . . . ; etc. For example, using six transducers on each ring can excite unwanted modes F_{T} (6,1), F_{L}(6,1), F_{T}(12,1), F_{L}(12,1), T(0,2), F_{L}(6,2), . . . etc. If these modes are not suppressed relatively to the wanted signal, the interpretation of the measured signal will be ambiguous and defects may be masked. The cut-on frequency of these unwanted modes is generally monotonic with the index ‘N’ given above.

In other embodiments other modes can be used as the wanted modes. For example in order to use mode F_{T} (1,1) as the wanted mode an embodiment of the system can transmit weighted versions of substantially the same signal simultaneously from all transducers on a ring of N transducers. The weights can be sin(2πk/N) where k is the transducer index along the circumference, and can be equal to k=0, 1 . . . N−1. For example, using six transducers on each ring can excite unwanted modes F_{T} (5,1), F_{T} (7,1), F_{L}(5,1), F_{L}(7,1), . . . etc. In a similar way, other embodiments may select other modes as the wanted mode.

Therefore, for the cut-on frequencies of the unwanted modes to be beyond the desired bandwidth's upper limit, a large number of transducers (N) is needed. Thus, it increases the available spectral bandwidth without unwanted modes. Consequently, one technique to avoid the presence of these modes in the desired frequency band, can involve increasing the number of transducers around the tube circumference. When inspecting narrow gauge tubes, such as those typically found in heat exchangers, it is difficult to fit a sufficient number of transducers into the limited space available. In addition, the cost of the transducers may also play a role for wide gauge pipes.

Some embodiments of a novel GW inspection system overcome the constraints introduced by the available space for mounting a plurality of transducers by using two or more rings of transducers. Each ring can be placed at a different axial location relative to the other rings. The transducers on one ring can be placed with a circumferential offset (“staggered”) relative to the transducers in another ring. Reflected signals that are received by the different rings can be combined to achieve a higher effective circumferential transducer count. In some embodiments the rings can have a similar number of transducers. In other possible embodiments each ring can have a different number of transducers. The transducers on one or more rings can be arranged at substantially the same distance from each other along the circumference of the ring. Yet in other embodiments, the transducers on one or more rings can be placed in unequal distance from each other along the circumference of the ring.

In order to measure the T(0,1) mode, a receiving ring having M transducers arranged in a substantially even spacing along the circumference of the tube can be used, by simple summing of the obtained signal of each of the transducers. However, in this case some unwanted modes may interfere with the measurement. The dominant unwanted modes may include: F_{T}(M,1); F_{T}(2M,1) . . . ; F_{L}(M,1); F_{L}(2M,1); . . . ; etc. In order to reduce the influence of the unwanted modes, one or more filters can be used to attenuate the signal at frequencies where unwanted modes interfere, for example near their cut-on frequencies. However, such filters can attenuate and/or distort the signal from the wanted modes.

Yet, another embodiment of the present disclosure uses a novel architecture of the transducers on each ring to increase the order of the unwanted modes, and therefore increasing the bandwidth in which the unwanted modes do not interfere. An example embodiment may have a different number of transducers arranged over each ring, (i.e. M is not equal to N). In some embodiments, the transducers on each ring can be arranged in a substantially equal distance from each other along the circumference. In other embodiments, the transducers on at least one ring can be arranged at uneven distances, where the distance between each two consecutive transducers can be different.

In an example embodiment, in order to use mode T(0,1), an example embodiment may transmit simultaneously the same excitation on N evenly spaced transducers located on one ring and may simply sum the signals that were received from the inspected tube via the M substantially evenly spaced transducers located on the other ring. In such an embodiment, the unwanted flexural modes, which are both excited and received are only those for which the mode-index ‘MI’ is divisible by both M and N. For example for N=6, M=5 the MI becomes 30, and the unwanted flexural modes will be F_{T}(30,1); F_{T}(60,1) . . . ; F_{L}(30,1); F_{L}(60,1); . . . . Thus, the new arrangement gives a bandwidth clear of unwanted modes up to the cut-on frequency of the lowest mode for which the index ‘MI’ is divisible by both M and N. In an embodiment that uses six transducers on one ring and five transducers on the other ring the first unwanted mode has an index MI=30, which has cut-on frequency that is higher than unwanted modes having MI=6 or MI=5. Thus, the new technique increases the bandwidth of the obtained and processed signal.

Another obstacle that can be associated with increasing the bandwidth of the propagating mechanical waves in the tube wall are resonances between the mechanical/electrical transducer and the wall of the inspected tube.

Further, in order to overcome the resonance phenomena associated with the interface between the GW transducers and the tube wall, some embodiments of the novel GW inspection system may use a partially-isolating-dry coupling element, which is placed between the GW transducer and the tube wall. This isolation can be achieved by using an attenuating dry coupling element between the GW transducer and the tube wall that suppresses the resonance and increases the bandwidth. In order to overcome the effect of the dry coupling element on the required signal-to-noise ratio, the excitation energy can be increased.

The above-described deficiencies of GW methods, do not limit the scope of the inventive concepts of the present disclosure in any manner. The deficiencies are presented for illustration only.

In the following description, for purposes of explanation, numerous specific details are set forth to assist in the understanding of the various embodiments and aspects of inventions presented within this document. It will be apparent, however, to one skilled in the art that embodiments of the invention may be practiced without some or all of these specific details. In other instances, structures and devices are shown in block diagram form to avoid obscuring the flexibility and variability of the embodiments of the invention. References to numbers without subscripts or suffixes are understood to reference all instances of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware. In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. Software of a logical module may be embodied on a computer readable medium such as a read/write hard disc, CDROM, Flash memory, ROM, or other memory or storage, etc. In order to execute a certain task a software program may be loaded to an appropriate processor as needed. In the present disclosure the terms task, method, process can be used interchangeably.

These and other aspects of the disclosure will be apparent in view of the attached figures and detailed description. The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE DRAWINGS

Some examples of embodiments of the present disclosure will be understood and appreciated more fully from the following detailed description, taken in conjunction with the drawings in which:

FIG. 1A illustrates relevant elements in an axial cross-section view of an example of a GW probe for tube inspection;

FIG. 1B illustrates a cross-section view along the cut-line AA of the probe that was illustrated in FIG. 1A.

FIG. 2 shows relevant elements of an example of Broadband-GW-Tube Inspection (BBGWTI) system;

FIG. 3 presents two graphs, the first one is related to a common GW inspection system while the second one is related to an example of BBGWTI; and

FIG. 4A and FIG. 4B shows a flowchart with relevant actions of an example process of inspecting a tube by an example of BBGWTI.

### DETAILED DESCRIPTION OF DIFFERENT EMBODIMENTS

Turning now to the figures in which like numerals represent like elements throughout the several views, different embodiments of the tube inspection system, as well as features, aspects and functions that may be incorporated into one or more such embodiments, are described. For convenience, only some elements of the same group may be labeled with numerals. The purpose of the drawings is to describe different embodiments and not for production. Therefore, features shown in the figures are chosen for convenience and clarity of presentation only. It should be noted that the figures are for illustration purposes only and are not necessarily drawn to scale. Moreover, the language used in this disclosure has been principally selected for readability and instructional purposes, and may not have been selected to delineate or circumscribe the inventive subject matter, resort to the claims being necessary to determine such inventive subject matter.

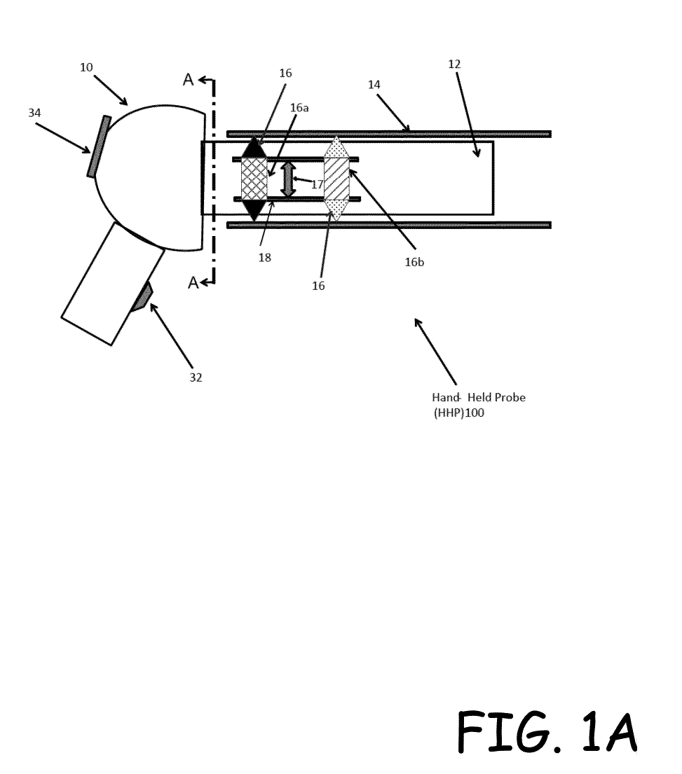

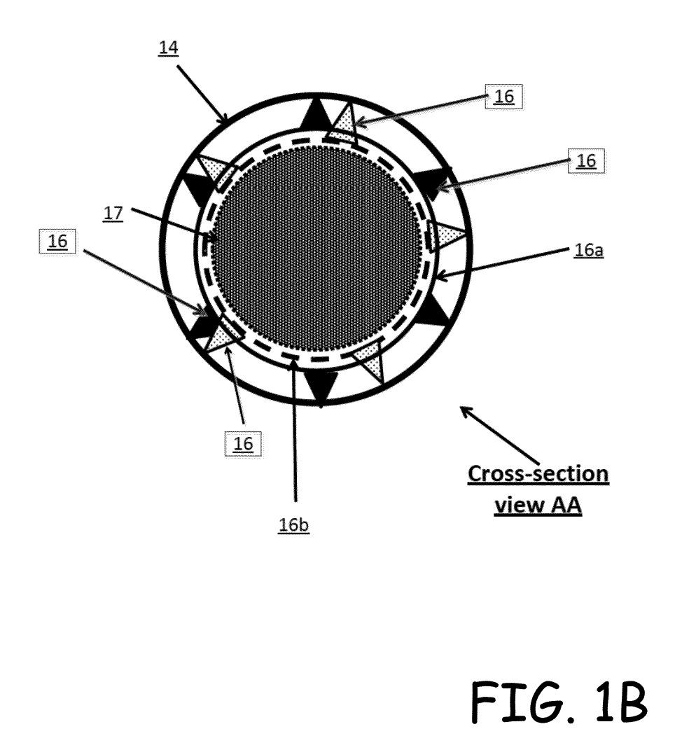

FIG. 1 illustrates an example of a hand-held probe (referred to herein as HHP) 100 of an example of a Broadband-GW-Tube Inspection (BBGWTI) system. The hand-held probe 100 can comprise a housing 10 to which a guided-wave-transducer mechanism can be either permanently affixed or detachably affixed. An example of the guided-wave-transducer mechanism can be a transducer cylinder 12. In other embodiments, not shown in the figures, the guided-wave-transducer mechanism can comprise two separate rings; each ring can comprise a plurality of transducers. Each ring can be placed adjacent to each other, along the external circumference of the tube. Other embodiments may use other types of guided-wave-transducer mechanisms. The transducer cylinder 12 can be inserted into a near-end of a tube to be inspected 14. The hand-held probe 100 can include or be coupled with a plurality of different sizes of transducer cylinders 12, wherein each transducer cylinder could fit a different internal diameter of an inspected tube 14.

An example of a transducer cylinder 12 can comprise a GW transducer mechanism 18, having two or more rings 16a and 16b where each ring can comprise a plurality of GW transducers 16 and a pressing mechanism 17. The plurality of GW transducers 16 are used for generating the guided waves in the tube under inspection 14 and for obtaining the reflected waves.

The first ring 16a can be referred to as a transmitting ring while the other ring 16b can be referred to as the receiving ring. In other possible embodiments the first ring 16a can be used as the receiving ring, while the other ring 16b can be used as the transmitting ring. In some embodiments a plurality of measuring cycles can be implemented one after the other. In each cycle the task of the rings can be changed. In the first cycle the first ring 16a can be used as the transmitting one, while in the second cycle it can be used as the receiving one, etc. Thus, for any measuring cycle, any of the rings may be transmitters or receivers and such role may be switched in any subsequent cycle.

In some embodiments each ring, 16a and 16b represent multiple rings, the main ring 16a or 16b and one or more subrings (for convenience and simplicity the subrings are not shown in the figures). Each subring comprises a similar number of transducers as its associated main ring 16a (N transducers) or 16b (M transducers). The subrings can be used to distinguish between left and right (back and forward) propagating waves. The technique of determining the direction is known to a person with ordinary skill in the art. Processing the signal from the subrings can be done in a similar way as it is disclosed for the main rings 16a and 16b and therefore will not be further discussed.

Each ring can be placed at a different axial location relative to the other rings. The transducers on one ring can be placed with a circumferential offset (“staggered”) relative to the transducers in another ring. Reflected signals that are received by the different transducers and/or rings can be combined to achieve a higher signal-to-noise ratio (SNR). The transducers on one or more rings can be arranged at substantially the same distance from each other along the circumference of the ring. Yet in other embodiments, the transducers on one or more rings can be placed in unequal distance from each other along the circumference of the ring. Throughout the description and the claims the two terms circumferential and azimuthal can be used interchangeably.

The number of transducers on each ring can be designed as a compromise between the diameter of the inspected tube and the required bandwidth of the system. In order to achieve a broadband system from low frequencies up to high frequencies, each ring comprises a different number of transducers. In an embodiment of a BBGWTI that uses the T(0,1) as the wanted mode to be excited in the tube wall, the first ring 16a can comprise N transducers while the other ring 16b can comprise M transducers.

An example embodiment may sequentially transmit the same excitation via each of the N transducers located on the first ring 16a and may simply sum the signals that were measured from the inspected tube via the M transducers located on the other ring 16b. In such an embodiment, the unwanted flexural modes, which are both excited and measured are only those for which the mode-index ‘MI’ is divisible by both M and N. For the example of FIG. 1A and FIG. 1B, wherein N=6 and M=5 the MI becomes 30, and the unwanted flexural modes will be F_{T}(30,1); F_{T}(60,1) . . . ; F_{L}(30,1); F_{L}(60,1); . . . . Thus, the bandwidth, which is significantly clear of unwanted modes, is increased up to the cut-on frequency of the lowest mode for which the index ‘MI’ is divisible by both M and N. In an embodiment that uses six transducers on one ring and five transducers on the other ring the first flexural unwanted mode has an index MI=30, which has cut-on frequency that is higher than unwanted modes having flexural MI=6 or MI=5.

The GW transducers 16 can be, but are not limited to, piezoelectric elements, EMAT (ElectroMagnetic Acoustic Transducer) transducers, magnetostrictive transducers, etc. The pressing mechanism 17 can be used for pressing the transducers 16 against the interior wall of the tube 14 while performing the measurements. In one embodiment, the pressing mechanism 17 can comprise mechanical linkages actuated by an electric motor or air pressure. In another embodiment, the pressing mechanism 17 could be an internal inflatable bladder that presses the GW transducers against the tube wall.

In some embodiments of the GW transducer mechanism 18, the GW transducers can comprise piezoelectric transducers 16. In some cases, at certain frequencies of mechanical vibrations, resonance can occur between the piezoelectric transducers 16 and the tube 14 under test. In order to suppress the resonance between a piezoelectric elements and the wall of the tube under inspection, some embodiments may use a partially-isolating-dry-coupling element. The partially-isolating-dry-coupling element can be added between the transducer and the tube wall for attenuating resonance. Suppressing the resonance conditions facilitates using wide bandwidth (BW) signal. The BW can be in the range of few tens of KHz up to few hundreds, 50 KHz up to 800 KHz width, for example.

As a non-limiting example, the partially-isolating-dry coupling element can be made from a composition of 5-35% of metal powder of diameter in the range of 0.1-50 microns, 10-50% adhesive material, and various additives that modify the mechanical properties. The percentage values are in volume. The metal powder can comprise metal, such as but not limited to, gold, silver, tungsten, or lead. The adhesive material can comprise epoxies resin, RTV, contact glue, etc. The additives can comprise material such as but not limited to polymers (e.g. PVC, polystyrene, polyamide), elastomers (latex, Nitrile rubber EPDM etc.), organic solvents and diluents.

The partially-isolating-dry coupling element may suppress the mechanical resonances between the transducer 16 and the tube 14 and prevent resonance at the required high frequency while increasing the useful bandwidth. In order to raise the SNR, embodiments of the hand-held probe 100 can overcome the attenuation of the absorbing element on the signal to noise ratio of the GW signals by increasing the mechanical energy delivered from the transducers 16. Throughout this description the terms “absorbing element” and “partially-isolating-dry coupling element” can be used interchangeably.

In some embodiments, the housing 10 can comprise one or more control buttons 32 or a keyboard for initiating measurements and entering data. It may also have a display unit 34 for conveying information to the user.

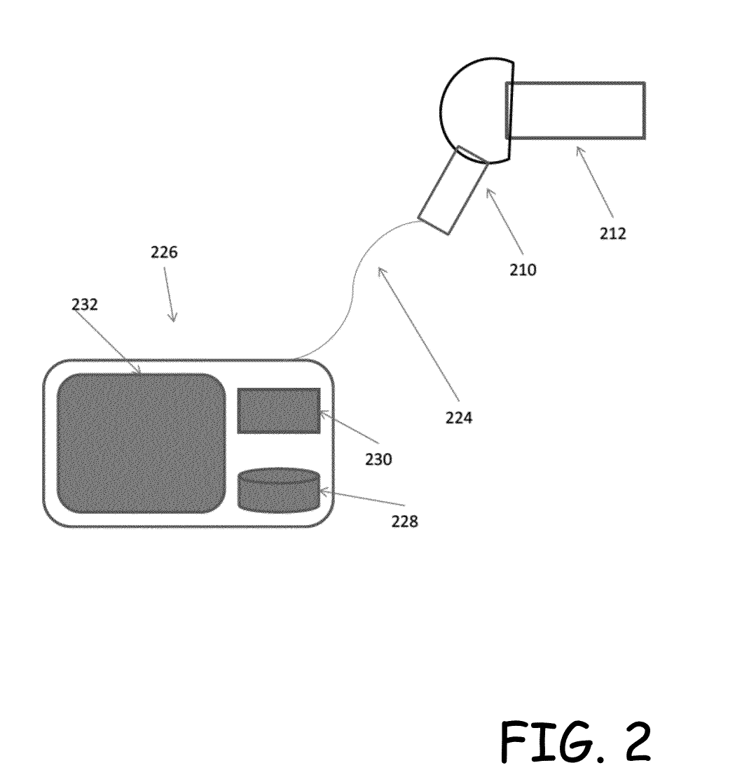

In more detail, the housing 10 is used to insert the transducer cylinder 12 into the interior of a tube under inspection 14. The pressing mechanism 17 is then initiated to hold the GW transducers 16 into place against the internal surface of inspected tube 14. A sequence of measurements is then initiated. One or more of transducers 16 on the first ring 16a serve as actuators that function to create the mechanical GW, while the transducers 16 on the other ring 16b serve as receivers, for example. All received mechanical signals are converted into electronic signals by the one or more transducers 16 of the second ring 16b. The electronic signals can be transmitted or communicated to a main processing unit (MPU 226), via cable 224, (FIG. 2) where they can be stored, or both.

In some embodiments, a detachable transducer cylinder 12 can have a shape of a cylinder with a near end and a far end. The external diameter of the cylinder 12 is less than the internal diameter (ID) of the tube under inspection 14. The near end of the detachable transducer cylinder 12 can comprise an adaptor (not shown in the drawings) that fits in one side the diameter of the opening of the housing 10 and on the other-side is adapted to the diameter of the detachable transducer cylinder 12. This adaptor can be referred to as a cylinder-housing-diameter-adaptation mechanism. Further, the adaptor includes a locking mechanism to lock the cylinder into place. The locking mechanism can include a threaded lock, a snapping lock or any of a variety of other mechanisms. A plurality of detachable transducer cylinders can be associated with the HHP 100. Each detachable transducer cylinder 12 can relate to a certain range of diameters of an inspected tube. An exemplary adaptor can comprise a threaded retainer and an electronic connector for attaching and detaching from the housing 10, for example.

Yet in other embodiments, not shown in the drawings, the detachable transducer cylinders 12 can comprise an identification member. The identification member can be configured to indicate the amount of rings that are included in the transducer cylinders 12, the number of transducers on each ring, etc. The identification member can comprise a kind of a plug that has a combination of pins that define the number of rings and transducers. The housing 10 can comprise a socket that matches the plug and can process the defined combination of rings and transducers. In other embodiments the identification member can include a series of holes that define the combination of the rings and the transducers, while the housing 10 can include an optical reader that can read the identification member. Other embodiments may use other methods for authenticating the number of rings and transducers on each ring. An example system can comprise a memory device, such as a Flash memory, that stores information on the number of rings, number of transducers on each ring, diameter, an RFID that can transmit the configuration when excited, etc. The memory device can be associated with a connector for communicating with a processing device.

FIG. 1B illustrates a front view of the transducer cylinder 12 along the cut-line AA that is illustrated in FIG. 1A. FIG. 1B illustrates an example of pressing mechanism 17 that is used to press the two rings 16a and 16b of GW transducers 16 toward the internal wall of the inspected tube 14. The example pressing mechanism 17 may comprise a balloon or inflatable insert. After inserting the transducer cylinder 12 (FIG. 1A) into a near end opening of the inspected tube 14, the balloon can be inflated with gas or fluid in order to push the two rings 16a and 16b toward the interior wall of the tube 14. In this non-limiting example the two rings are placed at a different axial locations relative to each other. In other embodiments, the different axial relative locations can be substantially zero. Further, the example of FIG. 1A and FIG. 1B has two rings. Other embodiments may have additional one or more rings of transducers. Further, other embodiments may use a structure of springs as the pressing mechanism 17 instead of the balloon or inflatable insert.

In the illustrated example, the first ring 16a contains six transducers, arranged substantially at an equal distance from each other. While the second ring 16b contains five transducers, arranged substantially at an equal distance from each other. In this non-limiting example, the same excitation may be delivered sequentially by the transducers of the first ring 16a. Per each transmitting cycle of each of the transducers of the first ring 16a, the obtained signal from each of the transducers of the second ring 16b, may be simply summed. Next the results of the simple sum per each transducer of 16a are simply summed to enhance the measurement of the wanted T(0,1) mode and suppress the unwanted modes. In an alternate embodiment a similar excitation signal can be delivered simultaneously by each of the transducers of the first ring 16a. The obtained signal from each of the transducers of the second ring 16b, may be simply summed to obtain a measured signal, in which the wanted T(0,1) mode is enhanced. In those examples of embodiments, the unwanted flexural modes, which interfere with the measurements are only those for which the mode-index ‘MI’ is divisible by both 6 and 5, which is equal to 30. Thus, the unwanted flexural modes will be F_{T}(30,1); F_{T}(60,1) . . . ; F_{L}(30,1); F_{L}(60,1); . . . . The cut-on frequency of mode index (MI) 30 is higher than unwanted modes having MI=6 or MI=5.

FIG. 2 illustrates an example of a BBGWTI having an HHP with a housing 210 and transducer cylinder 212 connected by a cable 224 to a main processing unit (MPU) 226. The cable 224 carries the signals between the housing 210 and the MPU 226. The MPU 226 can generate and transmit, via the cable 224, the electrical excitation signals toward the GW elements (transducer 16 on the ring 16a in FIG. 1A and FIG. 1B, for example). The electronic signals from the transducers 16 of ring 16b can be carried over cable 224 toward the MPU 226.

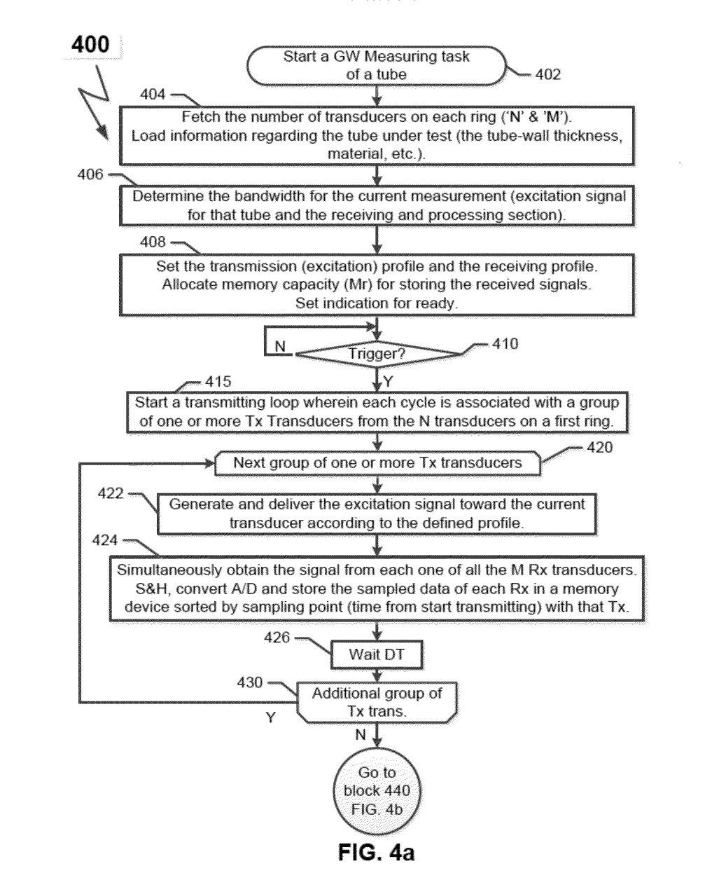

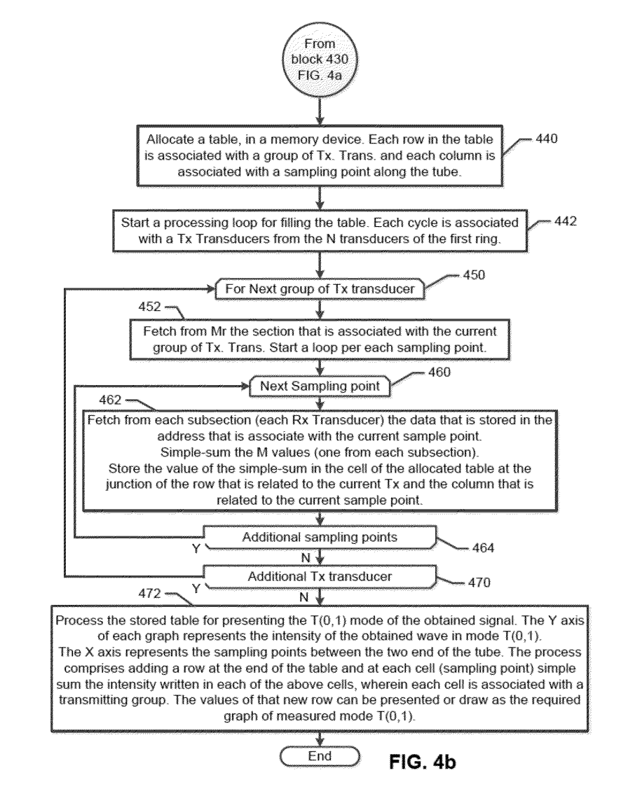

In some embodiments, the cable 224 can comprise pressure and/or vacuum lines for pressing mechanism 17 to be actuated and thus press the transducers 16, of rings 16a and 16b, against the interior wall of the tube under inspection 14 (FIG. 1A and FIG. 1B). The MPU 226 may comprise a storage medium 228 for recording the signals, software, reports, etc. In addition, the MPU 226 may comprise a processor 230. The processor 230 can be loaded from the storage medium 228 with software to execute the necessary processes for measuring the condition of the inspected tube, collecting the obtained signals, processing them, analyzing them, and delivering reports or output information to a display 232. An example of such a process is disclosed below in conjunction with FIG. 4A and FIG. 4B. The display unit 232 can be used as an interface between a user and the MPU 226. In addition MPU 226 can be connected to a printer (not shown in the drawings) in order to deliver printed reports.

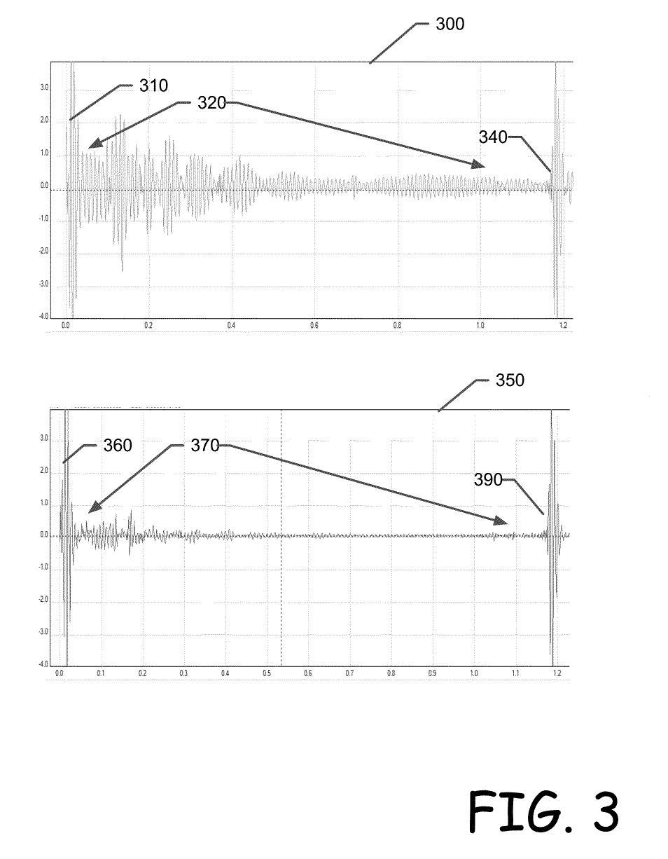

FIG. 3 presents two graphs representative of exemplary measurements that may be taken during the inspection of a clean tube, a substantially flaw-free tube, by two GW systems. The first graph 300 shows typical measurements that can be presented by a common GW inspection system having a similar number of transducers on each ring, six transducers for example. The second graph 350 illustrates typical measurements that could be obtained in an embodiment of a BBGWTI system having six transducers on the first ring 16a (FIG. 1A and FIG. 1B) and five transducers on the second ring 16b. In each graph, the horizontal axis, the ‘X’ axis, represents arbitrary time unit (thousands of sampling points, for example) along a monitoring period. The vertical axis, the ‘Y’ axis, represents arbitrary units of intensity of the measured waves that were obtained by the receiving transducers and were processed by the MPU 226 (FIG. 2) to be presented on the display unit 232, for example.

The excitation signal in both cases could be such as but not limited to: a pulse, a pseudo noise signal, swept sine, etc. The excitation signal is converted by the GW transducers to a torsional mechanical wave. The frequency band of the excitation signal can be adjusted to be less than to the cut-on frequency of mode T(0,2) that can be excited in the tube wall. In response to the excitation signal, a plurality of modes can be excited in the wall of the inspected tube and be reflected back from the tube toward the transducer cylinder 12.

The measured signals 310 and 360 in graphs 300 and 350, respectively, represent the intensity of the measured wave obtained by one or more receiving transducers, which were reflected from the near end of the inspected tube. The signals 340 and 390 in graphs 300 and 350, respectively, represent the intensity of the reflected mechanical wave from the far end of the inspected tube. The area marked in by arrows 320 and 370 in graphs 300 and 350, respectively, represent the intensity of the unwanted modes that were excited and measured by each of the systems, the common GW inspection system and an example of the BBGWTI system. A person with ordinary skill in the art will appreciate the improved results that were received in an example embodiment of the BBGWTI system (graph 350).

FIG. 4A and FIG. 4B illustrate a flowchart with relevant actions of an example process 400 for inspecting a tube by an example of a BBGWTI system. The process can be implemented by MPU 226 (FIG. 2). The process can be initiated 402 by a user after associating an appropriate transducer cylinder 12 with the housing 10 of the HHP 100 (FIG. 1A). The user can load the MPU 226 with information about the inspected tube 14, the transducer cylinder 12 (FIG. 1A), the bundle (if the tube is in a bundle of tubes), etc. The information about the tube 14 can comprise: the internal radius, external radius, length, material, etc. The information about the transducer cylinder 12 can include: number of transducers rings, 16a, 16b; number of transducers on each ring, etc.

In some embodiments of the HHP 100 (FIG. 1), the interface between the transducer cylinder 12 and the housing 10 can include an indicator that indicates the number of rings and the number of transducers on each ring. The indictor can be electrical switches that can be set according to the configuration of the cylinder. In alternate embodiments the indictor can be an optical indicator having a combination of holes, or a printed code such as a barcode, a dip-switch, an RFID, a readable memory element, etc. The housing can include a reader that matches the method that was implemented for the indicator and can automatically read and load the configuration of the transducers cylinder 12 to the MPU 226.

The MPU 226 can process 406 the loaded information about the tube and can estimate the cut-on frequencies of the relevant modes. The estimation can be based on a plurality of look-up-tables (LUT) that can be stored in the storage device 228. The relevant modes for N transducers on one ring and M transducers on the other ring can comprise the wanted mode T(0,1). In addition, the relevant modes can include the unwanted modes F_{T}(MN,1); F_{T}(2MN,1) . . . ; F_{L}(MN,1); F_{L}(2MN,1); T(0,2); T(0,3), etc. It should be noted the MN represents the multiplication of N times M. In embodiments in which the first ring has six transducers and the second ring has five transducers, then MN=30 and the relevant unwanted mode can be F_{T}(30,1); F_{T}(60,1) . . . ; F_{L}(30,1); F_{L}(60,1); T(0,2); T(0,3) etc.

Based on the estimated cut-on frequency of the different modes, the bandwidth of the system can be defined 406. In some embodiments the low frequency limit of the bandwidth can be determined based on the capabilities of the measuring system. The high frequency limit of the bandwidth can be less than the cut-on frequency of the first unwanted mode, 80% to 95% of the cut-on frequency of lower cut-on frequency of the first unwanted mode, for example. This bandwidth can define the bandwidth of the excitation signal that is delivered to the transmitting (Tx) transducers and the bandwidth that is used for processing the electronic signal that is obtained by the receiving (Rx) transducers.

After defining the wanted bandwidth, at block 408, an example of process 400 can define the excitation profile. The profile can comprise the energy; the shape of the excitation signal, a pulse, a pseudo noise signal, swept sine, etc.; the transmission time via each transducers; the delay between one transducer to the other; the sequence of the transducers in the transmitting profile; defining N groups of one or more transducers that can be activated simultaneously, etc. Next, memory resources (MR) can be allocated 408 for storing the values of the measured signals. At this point the BBGWTI system is ready to start evaluating a single tube or a first tube from a bundle of tubes. An indication “system ready”, which can be located over the display unit 34, can be turn on. At this point the MPU 226 can wait 410 until a user (or entity in embodiments that the inspection is performed by use of an automated machine) inserts the HHP 100 into a tube to be inspected and presses or actuates the button 32 (FIG. 1A) to trigger the measuring process, for example.

After 410 receiving the trigger, a transmitting loop between blocks 420 to 430 can be initiated 415. Each cycle in the loop can be associated with a group of one or more transducers of the first ring. The number of Tx transducers in a group can be in the range of one Tx transducer up to N transducers, wherein N is the number of Tx transducers on the ring. In an exemplary embodiment, the one or more Tx transducers of a group can be driven simultaneously by similar signals.

At block 420 the next group of one or more Tx transducers can be handled. According to the defined profile, which was defined in block 408, an electronic signal that matches the shape, frequency band, intensity and duration can be delivered 422 from MPU 226 toward the one or more Tx transducers of the current group. In embodiments in which the Tx transducers 16 (FIG. 1A) are piezoelectric transducers, the delivered 422 electronic signal from the MPU 226 are converted by the piezoelectric transducers to mechanical vibrations.

In association with the transmitting stage 422, a receiving process 424 can be executed. The receiving block 424 can be initiated at the beginning of the transmission. In other embodiments block 424 can be initiated with a little delay. The receiving block 424 can be terminated after the termination of the transmitting action 422 in order to allow ample time for the mechanical wave to propagate to the far end of the tube and return from the far end of the tube. During the receiving block 424, the signal from each receiving transducer (Rx transducer) out of the M transducers of the second ring, 16b (FIG. 1A), can be: sampled; converted from analog to digital; and stored in an appropriate location in the allocated MR. The appropriate location in the MR can be associated with the current Tx transducer that is used in this cycle of the transmitting loop, the relevant Rx transducer and the sampling time from the moment that the transmission was started. At the end of block 424, process 400 can wait 426 a few hundreds of milliseconds and check 430 if an additional group of Tx transducers exist. If there is another group, process 400 returns to block 420 and starts a new cycle for the next group.

If 430 there are no more transmitting groups then the transmitting loop can be terminated and process 400 can proceed to block 440 in FIG. 4B and start processing the stored information. At this point of the process the information stored in the allocated MR can comprise a plurality of sections, each section can be associated with a transmitting cycle of a group of one or more Tx transducers out of the N transducers of the first ring. Each section can be divided into M subsections. Each subsection can be associated with an Rx transducer from the M transducers of the second ring 16b. Each subsection can comprise a plurality of addresses, each address is associated with a sampling point and stores data that reflects the intensity of the obtained reflection signal from that Rx transducer at that sampling time from the excitation of the Tx transducer that is associated with that section.

In case of inspecting a bundle of a plurality of similar tubes, some embodiments of BBGWTI systems can be configured to repeat the actions from block 410 to 430 for multiple tubes within the bundle. In some embodiments, inspecting the other tubes can be done while processing the data of the previously inspected tubes. In other embodiments of an exemplary BBGWTI system, the process 400 can be configured to obtain the results from inspecting all the tubes or selected tubes from the bundle before processing the obtained data.

FIG. 4B illustrates an embodiment of a method that is used for handling the stored data or accumulated data that is related to a tube. The data may represent measurements for a single tube, one tube from the bundle of a plurality of similar tubes or multiple tubes in some embodiments. As mentioned above, block 440 can be initiated immediately after block 430 for each tube or, it can be initiated later on, after collecting data from other inspected tubes of a bundle of similar tubes. At block 440 a table is allocated for each tube to be inspected, into which the measured signals are recorded. Each row in the table can be associated with a transmitting group of one or more Tx transducers that were defined in the profile, at block 404, and be used in the cycles of the transmitting loop between blocks 420-430. Each column of the allocated table can be associated with a sampling point.

After preparing the table, process 400 can start 442 an external loop between blocks 450 to 470. Each cycle in the loop can be associated with a group of one or more Tx transducers and is targeted to calculate the intensity values per each cell (sampling point) along the row, which is associated with that group, in the allocated table. At block 450 the next group of Tx Transducers is handled. The stored data from the section that is related to that group of one or more Tx transducers is fetched 452 from the MR and an internal loop between blocks 460 to 464 is initiated, each cycle in the loop is associated with a sampling point.

The sampling points can be in time the domain or can be converted to the location domain along the tube. Converting from time to location can be done by using the length of the tube and calculating the time difference between the reflections received from the near end of the tube 360 (the end that interfaces with the HHP) and the far end of the tube 390 (FIG. 3).

At block 460 a cycle is initiated for the next sampling point. From each subsection (each Rx Transducer), method 400 can fetch the data that is stored in the address that is associated with the current sample point and simple-sum the M values (one from each subsection) that were fetched. Next the value of the simple-sum can be stored in the cell in the allocated table at the junction of the row that is related to the current group of Tx transducers and the column that is related to the current sample point. Other example embodiments of method 400 may use other combining algorithms to define the intensity value of the measured signal at that sampling point. In some embodiments, weighted summing can be used to compensate for the differences between the transducers.

After storing the value of the simple-sum in the appropriate cell of the table, a decision can be made 464 whether there are more sampling points. If 464 there are more sampling points, then method 400 returns to block 460 for calculating the simple-sum value for the next sampling point. If 464 there are no additional sampling points, then the internal loop (the loop that is associated with a certain group of Tx transducers) is terminated and the process 400 proceeds to block 470.

At block 470 a decision is made whether there are more groups of Tx transducers. If 470 yes, then process 400 returns to block 450 starting a new cycle of the external loop for handling the results of the next group of one or more Tx transducers. If 470 there are no more groups of Tx transducers, then at block 472 the data stored in the table can be further processed. At this point of the process, each row, from the N rows, in the table is associated with a group of transmitting transducers and each column is associated with a sampling point.

A new row can be added 472 at the bottom of the table. The new row can be used for storing the intensity values, per each sampling point, which will be obtained by simple sum of the values written in each of the above cells (each cell is associated with a group of transmitting transducers). In the values that are stored in the new row, the wanted mode T(0,1) is enhanced.

A graph can be illustrated 472 according to the values stored in each cell of the new row. The graph can be plotted on a printer or can be presented on the monitor 232 (FIG. 2). The points along the X axis are sampling points that can be presented in the time domain. In some embodiments the sampling points can be converted into the location domain along the length of the tube. The location can be calculated based on the time interval between the two signals 360 and 390 (FIG. 3) and the known length of the tube. The Y axis represents the intensity, the value of measured waves in which the wanted mode T(0,1) at each sampling point, is enhanced.

The graph can be observed by the user to determine the condition of the tube. After observing the graph of a certain tube, the user can instruct the MPU 226 to execute the processes of blocks 440-472 for the next tube, and so on. In some embodiments, the graph can be printed automatically and process 400 can move to the next tube automatically. Other embodiments of the BBGWTI system can use an automatic method for analyzing the graph of each of the tubes. An example of an automatic process can search for areas of sampling points in which the intensity of the measured signal is above a certain threshold value. The length of such an area can be estimated for determining whether it is larger than another threshold, etc. Such a system can deliver a printed report with the printed graphs. At the end of processing, the data for all the tubes process 400 can be terminated. In some embodiments, at the end of the process the tables can be stored in a database 228 with information on the date, name of the user, etc. to be used later on during the following monitoring periods for determining changes in the condition of the tubes, and for statistics, for example.

In other embodiments in which mode F_{T} (1,1) is defined as the wanted mode the simple sum in block 462 will become a weighted sum in which the weights can be sin(2πk/M) where k is the transducer index along the circumference, and can be equal to k=0, 1 . . . M−1. The simple sum in block 472 will become a weighted sum in which the weights can be sin(2πl/N) where ‘l’ is the transducer index along the circumference, and can be equal to ‘l’=0, 1 . . . N−1. In a similar way, other embodiments may select other modes as the wanted mode.

The above description is intended to be illustrative, and not restrictive. For example, the above-described embodiments may be used in combination with each other. Many other embodiments will be apparent to those of skill in the art upon reviewing the above description.

The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein”.

What is claimed is:

1. A method for inspecting the condition of a tube, the method comprising the actions of:
a. employing a guided-wave-transducer mechanism (GWTM) that is configured to be associated with a tube to be inspected, wherein the GWTM has a first ring having ‘N’ guided-wave transducers (GWTs) distributed along the first ring, and a second ring having ‘M’ guided-wave transducers (GWTs) distributed along the second ring;
b. exciting mechanical waves by the GWTs of the first ring such that at least a portion of the mechanical waves propagates in the wall of the tube to be inspected and along an axis of the tube to be inspected;
c. converting the mechanical waves, by each of the ‘M’ GWTs of the second ring, into an electronic signal that is transferred from each GWTs of the second ring toward a processor;
d. processing, at the processor, the converted ‘M’ electronic signals for providing a measured signal in which a wanted mode is enhanced;
e. wherein ‘N’ and ‘M’ are integer numbers equal or greater than two and are not equal to each other.

2. The method of claim 1, wherein the wanted mode is an axisymmetric torsional mode.

3. The method of claim 2, wherein the action of processing the converted ‘M’ electronic signals further comprising a simple sum of the ‘M’ electronic signals for each of the excitation cycles for providing N electronic signals, each reflects the intensity related to an excitation cycle, and a simple sum of the N electronic signals for providing a measured signal in which an axisymmetric torsional mode is enhanced.

4. The method of claim 1, wherein the wanted mode is T(0,1).

5. The method of claim 1, wherein the action of exciting mechanical waves further comprises:
a. defining ‘N’ different transmitting groups, wherein each transmitting group includes one or more GWTs out of the ‘N’ GWTs of the first ring; and
b. providing ‘N’ excitation cycles, each providing energy for exciting of mechanical waves such that at least a portion of the mechanical waves propagate in the wall of the tube to be inspected and along the axis of the tube to be inspected, wherein each excitation cycle is associated with one of the ‘N’ different transmitting groups.

6. The method of claim 5, wherein the converting action and the processing action are repeated for each excitation cycle.

7. The method of claim 1, wherein the GWT is a piezoelectric transducer.

8. The method of claim 1, wherein the GWTs of at least one of the rings are distributed such that the distances, between any adjacent two GWTs, are substantially equal to each other.

9. The method of claim 1, wherein the GWTM is a cylinder.

10. The method of claim 9, wherein the GWTM is associated with the internal side of the tube to be inspected.

11. The method of claim 1, wherein the GWTM is associated with the external side of the tube to be inspected.

12. The method of claim 1, wherein the action of exciting mechanical waves further comprises providing simultaneously similar excitation energy to each of the N transducers of the first ring.

13. The method of claim 12, wherein the action of processing the converted ‘M’ electronic signals further comprising obtaining a simple sum of the ‘M’ electronic signals for providing an electronic signal that enhances the intensity of mode T(0,1) of the obtained waves.

14. A probe for inspecting a tube, the probe comprising:
a guided-wave-transducer mechanism (GWTM) that is configured to be associated with a tube under inspection, wherein the GWTM has a first ring having ‘N’ guided-wave transducers (GWTs) distributed along of the first ring, and a second ring having ‘M’ guided-wave transducers (GWTs) distributed along the second ring;
a housing that is configured to communicate with the N transducers of the first ring and the M transducers of the second ring; and
wherein the GWTM further comprises a pressing mechanism that is configured to press the plurality of the guided-wave transducers of the first ring and the second ring toward the wall of the tube, when the GWTM is associated with the tube;
wherein ‘N’ and ‘M’ are integer numbers equal or greater than two and are not equal to each other.

15. The probe of claim 14, wherein the GWT is a piezoelectric transducer.

16. The probe of claim 14, wherein the GWTs of at least one of the rings are distributed such that the distances, between any adjacent two GWTs, are substantially equal to each other.

17. The probe of claim 14, wherein the GWTM is a cylinder that is configured to be associated with the internal side of the tube under inspection.

18. The probe of claim 14, wherein the GWTM is associated with the external side of the tube under inspection.

19. The probe of claim 14, wherein the GWT is a piezoelectric transducer.

20. The probe of claim 14, wherein at least one of the guided-wave transducers from the plurality of the guided-wave transducers have a partially-isolating-dry coupling element at the edge of the guided-wave-transducers that faces toward the wall of the tube under inspection.

21. The probe of claim 20, wherein the partially-isolating-dry coupling element is pressed against the wall of the tube under inspection to associate the GWTM with the tube under inspection.

22. The probe of claim 20, wherein partially-isolating-dry coupling element suppresses mechanical resonance energy that is transferred between the mechanical wave transducers and the wall of the tube under inspection.

23. The probe of claim 14, wherein the mechanical waves are guided waves (GW).

24. A tube inspection system comprising:
a. a guided-wave-transducer mechanism (GWTM) that is configured to be associated with a tube under inspection, wherein the GWTM has a first ring having ‘N’ guided-wave transducers (GWTs) distributed thereon, and a second ring having ‘M’ guided-wave transducers (GWTs) distributed thereon; and
b. a controller having a processor, a human interface device, a memory device and a communication link with the GWTM;
c. wherein the controller is configured to:
i. excite mechanical waves by the GWTs of the first ring such that at least a portion of the mechanical waves propagates in the wall of the tube under inspection and along its axis;
ii. obtaining from each of the ‘M’ GWTs of the second ring, electronic signals which were converted from mechanical waves that propagate in the wall of the tube under inspection and along its axis;
iii. processing the converted ‘M’ electronic signals for providing a measured signal in which a wanted mode is enhanced.

25. The system of claim 24, wherein ‘N’ and ‘M’ are integer numbers equal or greater than two and are not equal to each other.

26. The system of claim 24, wherein the wanted mode is an axisymmetric torsional mode.

27. The system of claim 24, wherein the wanted mode is T(0,1).

28. The system of claim 24, wherein the controller, in order to excite the mechanical waves in mode T(0,1), is configured to:
a. define ‘N’ different transmitting groups, wherein each transmitting group includes one or more adjacent GWTs out of the ‘N’ GWTs of the first ring; and
b. providing ‘N’ excitation cycles, each providing energy for exciting of mechanical waves such that at least a portion of the mechanical waves propagate in the wall of the tube under inspection and along its axis, wherein each excitation cycle is associated with a different one of the ‘N’ different transmitting groups.

29. The system of claim 28, wherein the controller is configured to process the converted ‘M’ electronic signals by further comprising a simple sum of the ‘M’ electronic signals for each of the excitation cycles for providing N electronic signals, each reflects the intensity related to an excitation cycle, and a simple sum of the N electronic signals for providing a measured signal in which an axisymmetric torsional mode is enhanced.

30. The system of claim 29, wherein the axisymmetric torsional mode is T(0,1) mode.

31. The system of claim 24, wherein the GWT is a piezoelectric transducer.

32. The system of claim 24, wherein the GWTs of at least one of the rings are distributed such that the distances, between any adjacent two GWTs, are substantially equal to each other.

33. The system of claim 24, wherein the GWTC is associated with the internal side of the wall of the tube under inspection.

34. The system of claim 24, wherein the GWTs of at least one of the rings are distributed such that the distances, between any adjacent two GWTs, are substantially equal to each other.

35. The system of claim 24, wherein the GWTM is a cylinder.
